(19) United States
(12) Patent Application Publication
(10) Pub. No.: US 2001/0045417 A1
(43) Pub. Date: Nov. 29, 2001

(54) Implementation of laser technology

(76) Inventor: Alon M. Kapel, Givat Ela (IL)

Correspondence Address: ABELMAN FRAYNE & SCHWAB, Attorneys at Law, 150 East 42nd Street, New York, NY, 10017, US

(21) Appl. No.: 09/789,462

(22) Filed: Feb. 21, 2001

Related U.S. Application Data
(60) Provisional application No. 60/184,287, filed on Feb. 23, 2000.

(51) Int. Cl. B23K 26/00

(52) U.S. Cl. 219/121.68; 430/269; 430/945; 219/121.65; 219/121.66; 219/121.67; 219/121.69

(57) ABSTRACT

A system and methodology for laser mass customization of integrated circuits including a mask exposure subsystem operative to configure at least one conductive layer forming part of an integrated circuit and a laser customization subsystem operative to individually customize the at least one conductive layer.

### FIELD OF THE INVENTION

The present invention relates to laser customization of integrated circuits generally.

### BACKGROUND OF THE INVENTION

The following U.S. patents are considered to represent the current state of the art: U.S. Pat. No. 5,985,518; 5,861,641; 5,818,728; 5,679,967; 5,619,062; 5,565,758; 5,545,904; 5,541,814; 5,260,597; 5,128,601; 5,111,273; 5,049,969); 5,027,027.

### SUMMARY OF THE INVENTION

The present invention seeks to provide improved systems and methodologies for laser customization of integrated circuits.

There is thus provided in accordance with a preferred embodiment of the present invention a methodology for laser mass customization of integrated circuits including:

providing a substrate;

forming at least one semiconductor layer over the substrate; and

forming a plurality of conductive layers over the semiconductor layer, wherein at least one of the plurality of conductive layers is individually customized by employing a laser.

Preferably, the forming includes:

defining at least one of the plurality of conductive layers by exposing photoresist to light; and

individually customizing at least a portion of at least one of the plurality of conductive layers by causing laser light to impinge on the photoresist.

In accordance with a preferred embodiment of the present invention, the defining and the individually customizing each include exposing an area of the photoresist layer.

Preferably, an area exposed by the individually customizing is substantially smaller than an area exposed by the defining.

In accordance with a preferred embodiment of the present invention, the individually customizing has an overall duration which is substantially smaller than the overall duration of the defining.

Preferably, the individually customizing employs a beam having an intensity which is substantially greater than the intensity of light employed in the defining.

In accordance with a preferred embodiment of the present invention, exposure by the individually customizing is effected on the fly.

Preferably, the exposing which provides the individually customizing takes place generally concurrently with the exposing which provides the defining.

In accordance with a preferred embodiment of the present invention, the substrate includes a silicon wafer including a plurality of integrated circuit dies and wherein each of the plurality of integrated circuit dies is individually customized by employing the laser.

There is also provided in accoordance with a preferred embodiment of the present invention a system for laser mass customization of integrated circuits including:

mask exposure subsystem operative to configure at least one conductive layer forming part of an integrated circuit; and

a laser customization subsystem operative to individually customize the at least one conductive layer.

Preferably, the mask exposure subsystem and the laser customization subsystem are both operative waferwise on a substrate containing a plurality of integrated circuit dies.

In accordance, with a preferred embodiment of the present invention, the mask exposure subsystem and the laser customization subsystem operate at at least partially overlapping times on a given conductive layer.

Preferably, the mask customization subsystem is operative to configure the at least one conductive layer by exposing photoresist to light and the laser customization subsystem is operative to further configure the at least one conductive layer by causing laser light to impinge on the photoresist.

In accordance with a preferred embodiment of the present invention, the mask customization subsystem employs light having an intensity which is substantially less than the intensity of a beam of light employed by the laser customization subsystem.

Preferably, the laser customization subsystem is operative on the fly.

In accordance with a preferred embodiment of the present invention, the laser customization subsystem includes a customization engine providing customization outputs to a laser for making individual customization markings on each of a plurality of integrated circuit dies.

Preferably, the laser customization subsystem customizes at least one conductive layer. Additionally or alternatively, th, the laser customization subsystem customizes at least one interconnect layer.

Preferably, the mask customization subsystem employs light having an intensity which is substantially less than the intensity of a beam employed by laser customization subsystem. dr

### BRIEF DESCRIPTION OF THE DRAWINGS

The present invention will be understood and appreciated more fully from the following detailed description, taken in conjunction with the drawings in which:

FIG. 1 is a simplified pictorial illustration of a system and methodology for laser mass customization of integrated circuits in accordance with a preferred embodiment of the present invention;

FIGS. 2A, 2B, 2C, 2D, 2E, 2F, 2G, 2H and 2I are simplified pictorial illustrations illustrating alternative embodiments of laser mass customization of integrated circuits in accordance with preferred embodiments of the present invention; and

FIGS. 3A, 3B, 3C, 3D, 3E, 3F, 3G, 3H, 3I and 3J are simplified pictorial illustrations illustrating alternative embodiments of laser mass customization of integrated circuits in accordance with preferred embodiments of the present invention.

### DETAILED DESCRIPTION OF PREFERRED EMBODIMENTS

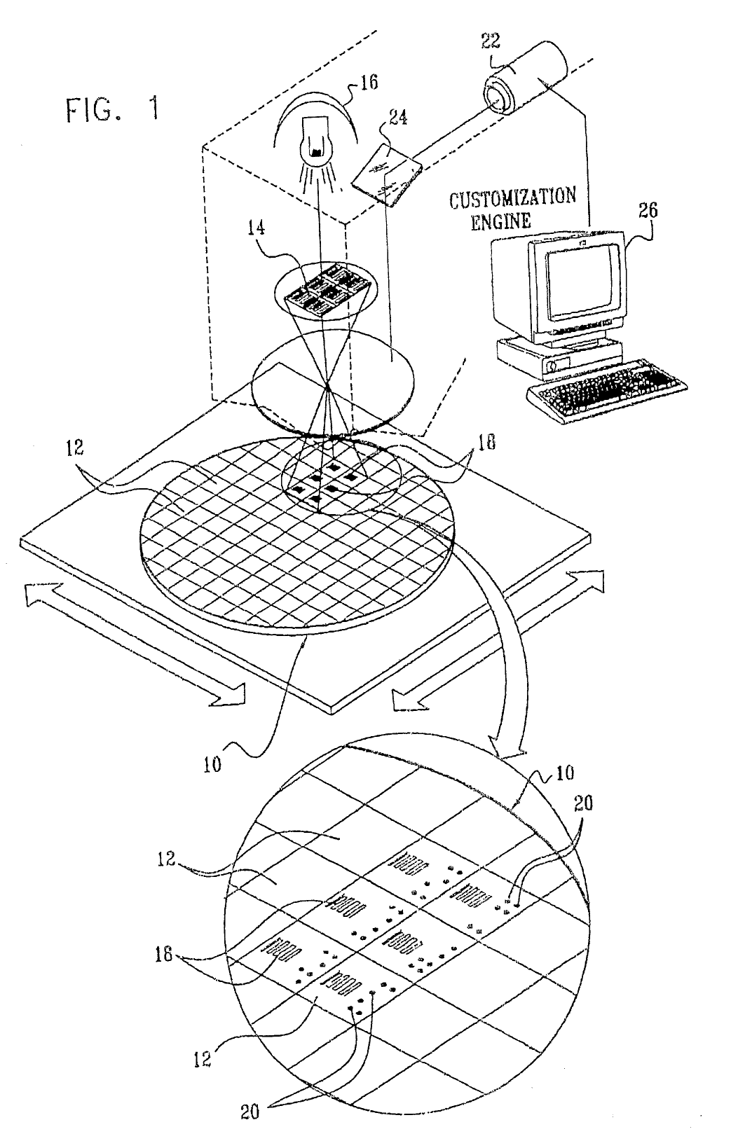

Reference is now made to FIG. 1, which a simplified pictorial illustration of a system and methodology for laser mass customization of integrated circuits in accordance with a preferred embodiment of the present invention. As seen in FIG. 1, a silicon substrate 10, including a multiplicity of integrated circuit dies 12 undergoes a photolithography process employing at least one mask 14 and a light source 16 to form an integrated circuit 18 on each die.

In accordance with a preferred embodiment of the present invention, each integrated circuit is individually customized with one or more individual customization markings 20. Preferably such individual customization is carried out using a laser 22 and associated laser optics 24 in conjunction with a standard substrate displacement mechanism (not shown), such as an X-Y stepper, used in conventional mask photolithography methodologies, which supports substrate 10. It is appreciated that the laser optics 24 may employ some or all of the optics employed for the standard photolithography process.

The laser 22 may be driven by a customization engine 26, such as a computer, which may generate identification or other customization codes, which are preferably encrypted, for providing unambiguous identification of each integrated circuit.

It is a particular feature of the present invention that the laser customization may be carried out as part of the standard fabrication process for integrated circuits on a waferwise basis. More specifically, it is a particular feature of the present invention that individual customization is carried out at the same stage that mask exposure is carried out. Both mask exposure and individual customization may be carried out simultaneously.

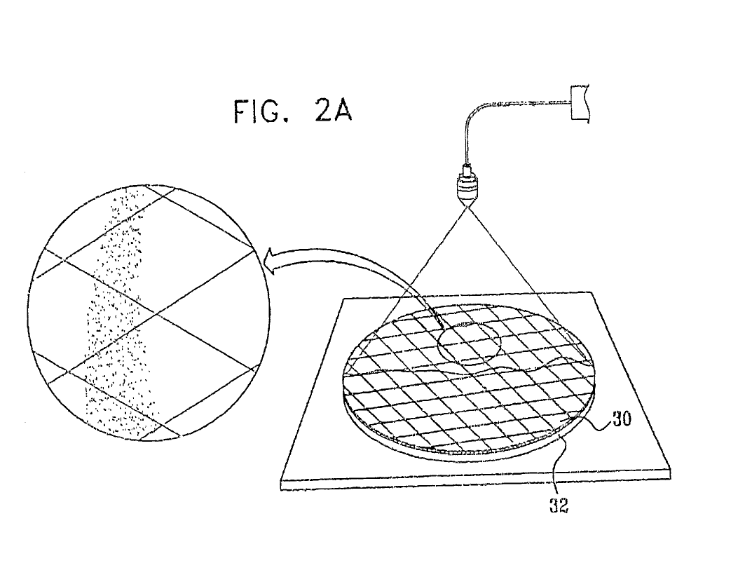

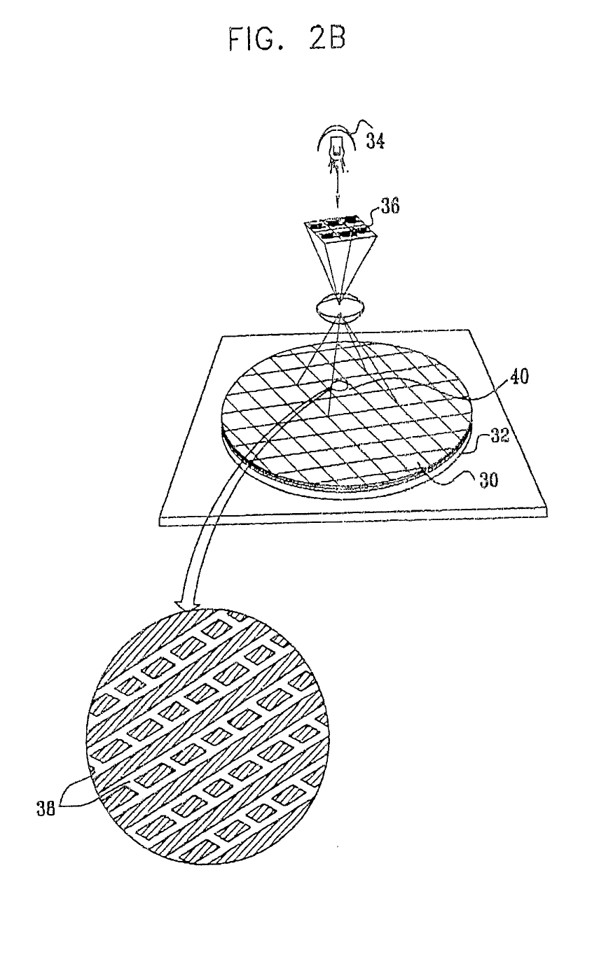

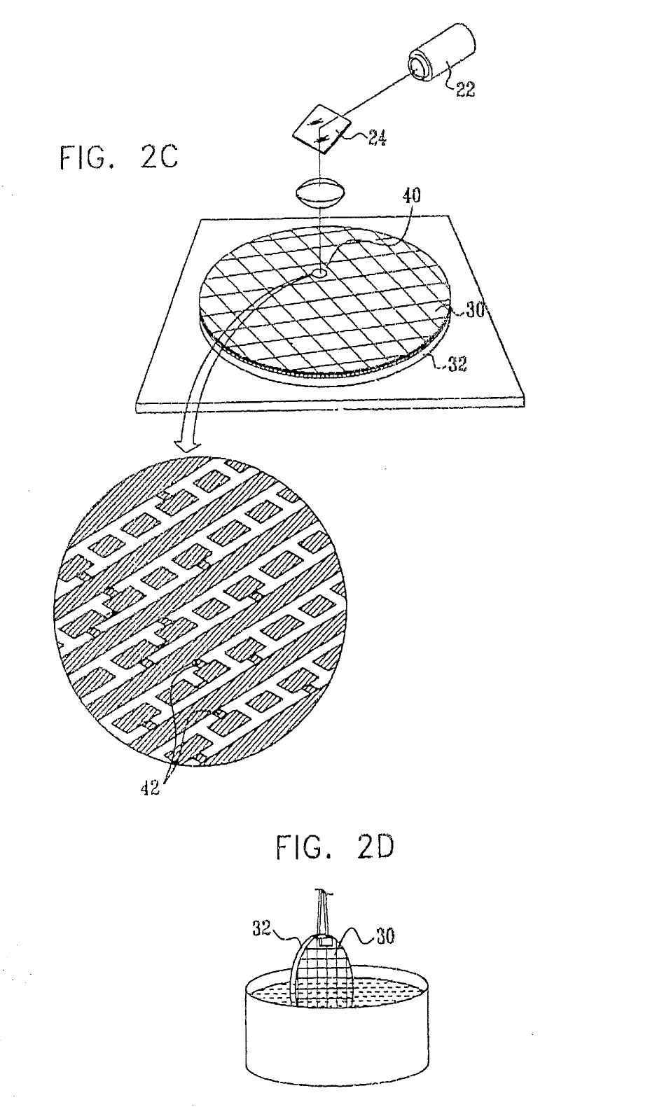

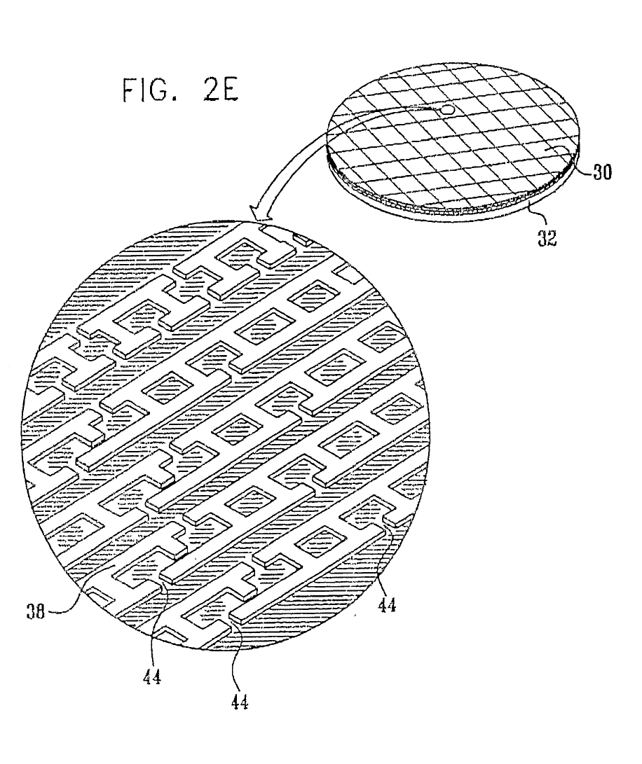

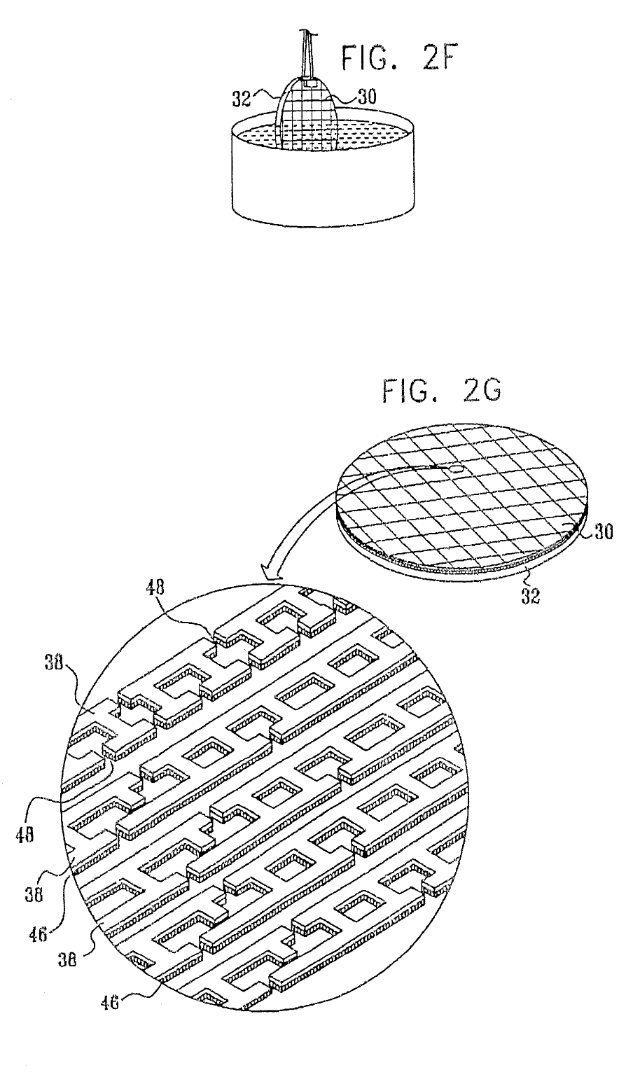

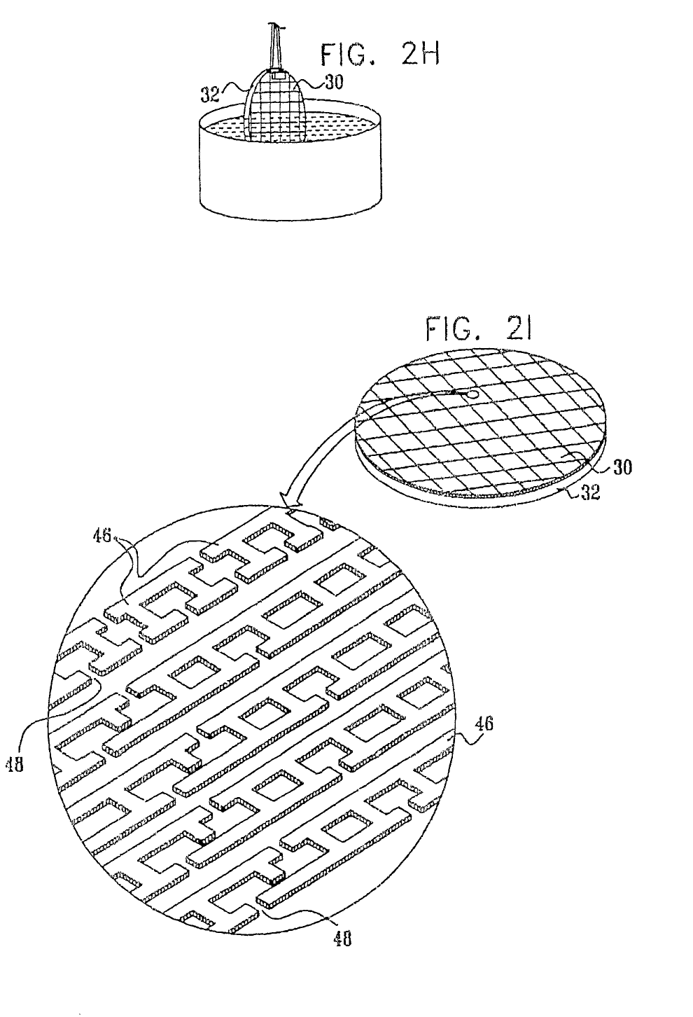

Reference is now made to FIGS. 2A, 2B, 2C, 2D, 2E, 2F, 2G, 2H & 2I which are simplified pictorial illustration illustrating various stages in laser mass customization of integrated circuits in accordance with preferred embodiments of the present invention.

FIG. 2A illustrates in initial stage wherein a layer 30 of photoresist is formed over a water 32 having semiconductor elements formed thereon. FIG. 2B shows exposure of layer 30 by light from a light source 34 via a mask 36 to form photoresist patterns 38 corresponding to conductive patterns in a die 40 on wafer 32.

FIG. 2C shows laser customization of layer 30 at die 40, which defines customization markings 42 at each die. Preferably, each die may be distinguished from every other die by the nature and/or location of the customization markings 42 thereon. Following the mask exposure step of FIG. 2B and the laser exposure step of FIG. 2C, the layer 30 may be developed in a conventional manner, as shown in FIG. 2D. It is a particular feature of the invention that the laser customization need not require a separate or additional development step.

Reference is now made to FIG. 2E, which shows wafer 32 following the development step of FIG. 2D. It is noted that the laser customization step of FIG. 2C results, in the illustrated example, in customized breaks 44 in the photoresist patterns 38 corresponding to customized breaks in the conductive patterns. Thus it may be appreciated that each integrated circuit produced by the methodology described hereinabove may be not only visually distinct from every other integrated circuit but may also be electrically different, such that its identity may be ascertained electrically, as by electrical interconnection with pads thereof.

Following the conventional development step of FIG. 2D, the wafer 32 is subjected to a conventional etching step shown in FIG. 2F. The results of this conventional etching step are shown in FIG. 2G, where it is seen that conductive pattern 46 are formed corresponding to and underlying photoresist patterns 38 and are formed with customized breaks 48 therein corresponding to the customized breaks 44 in the photoresist patterns 38 (FIG. 2E).

Following the conventional etching step shown in FIG. 2F, the wafer 32 is subjected to a conventional photoresist removal step shown in FIG. 2H which removes the photoresist patterns 30, leaving the conductive patterns 46 intact, as seen in FIG. 2I. The customized breaks 48 in conductive patterns 46 enable each die to have a customized identity and/or electrical function.

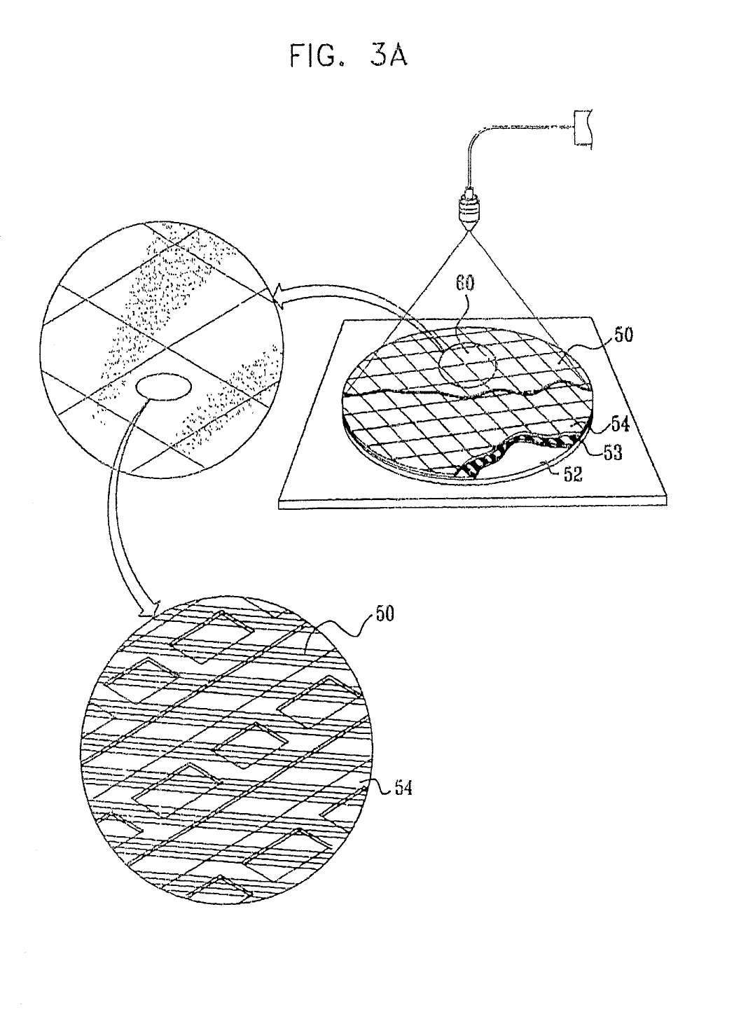

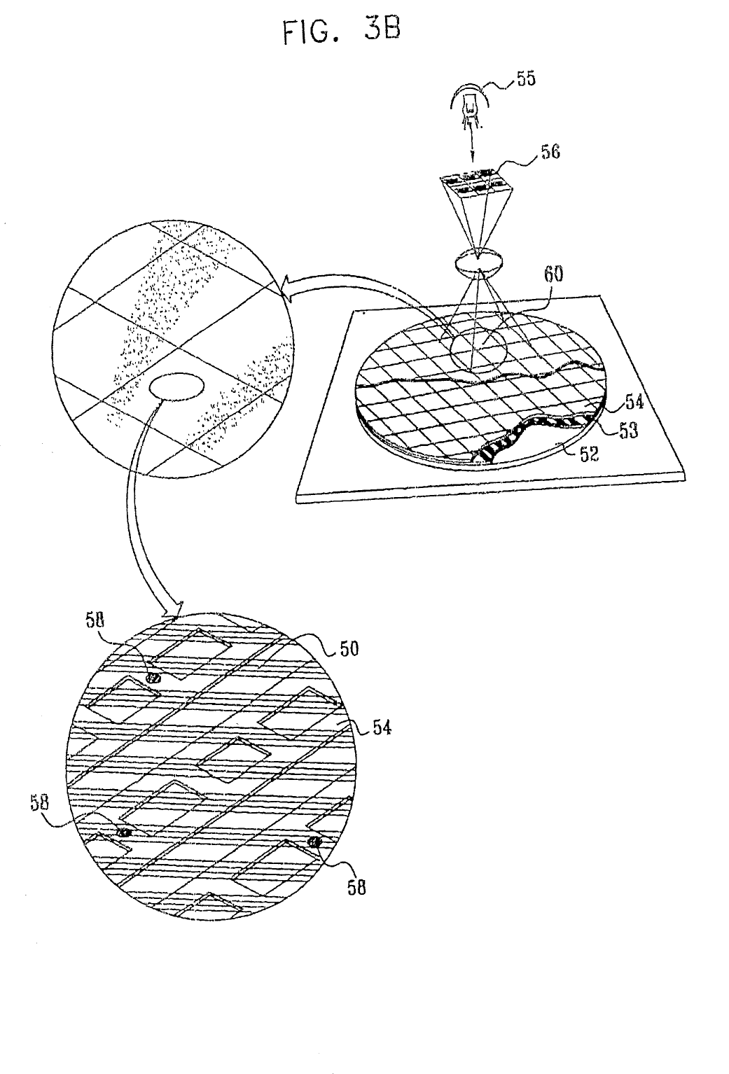

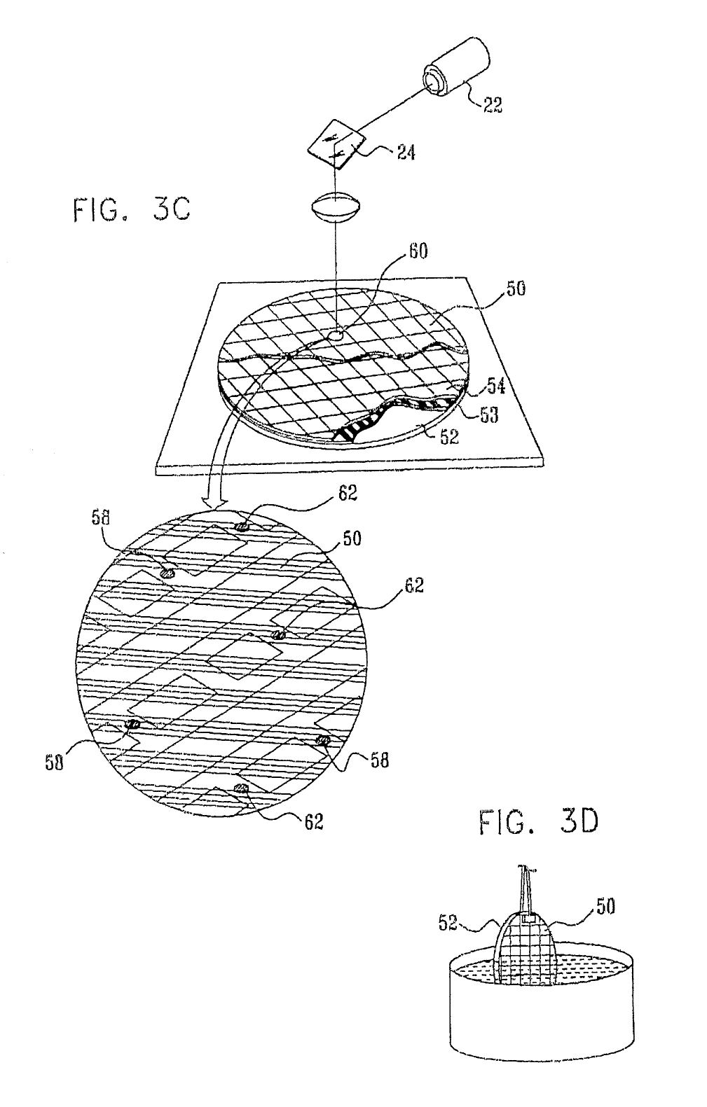

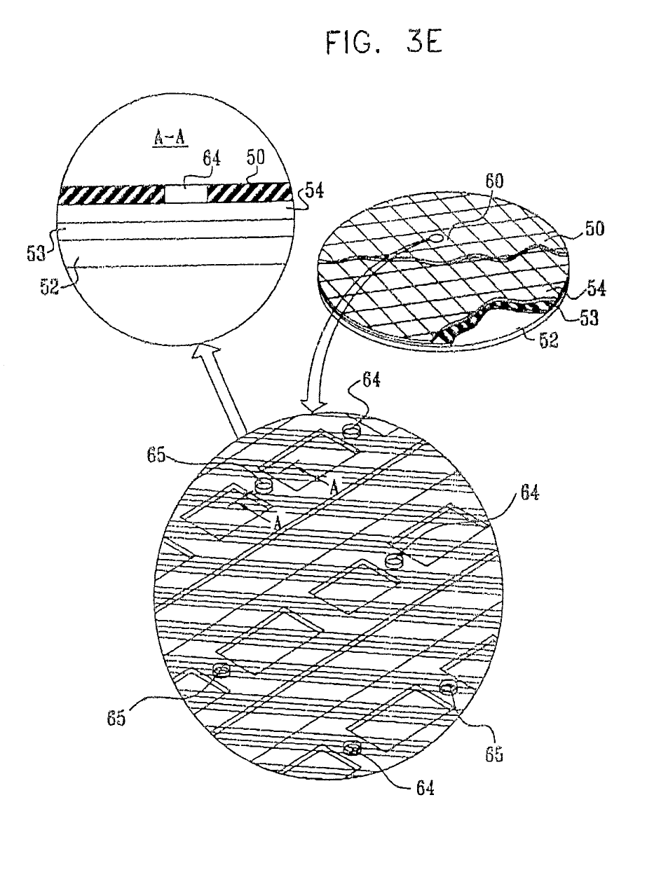

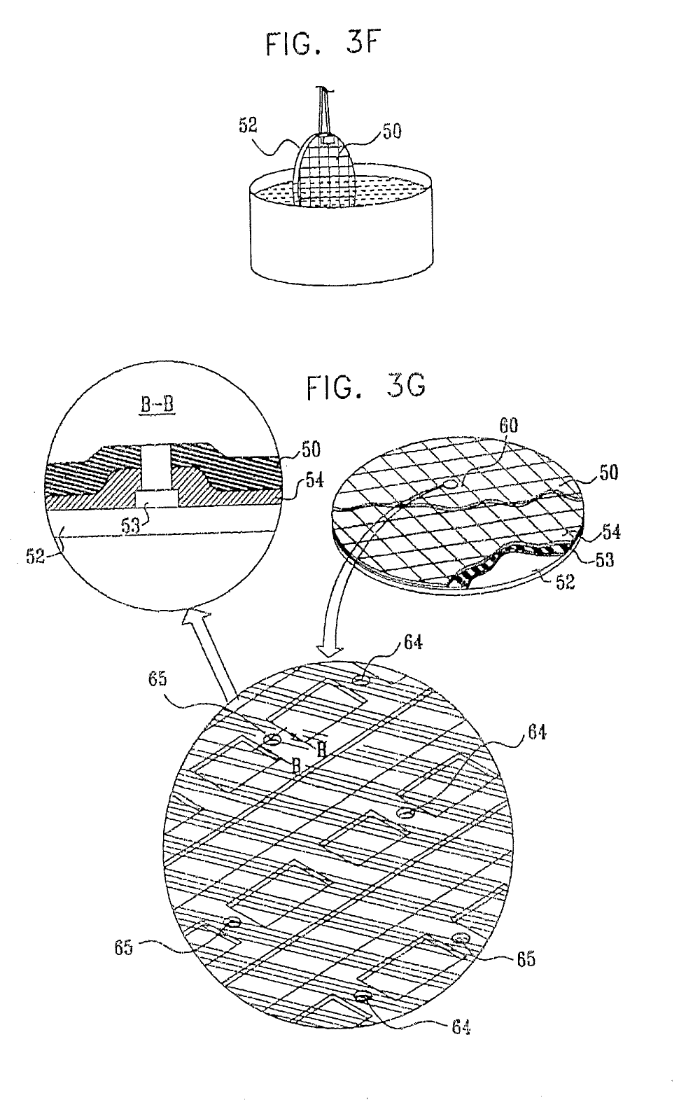

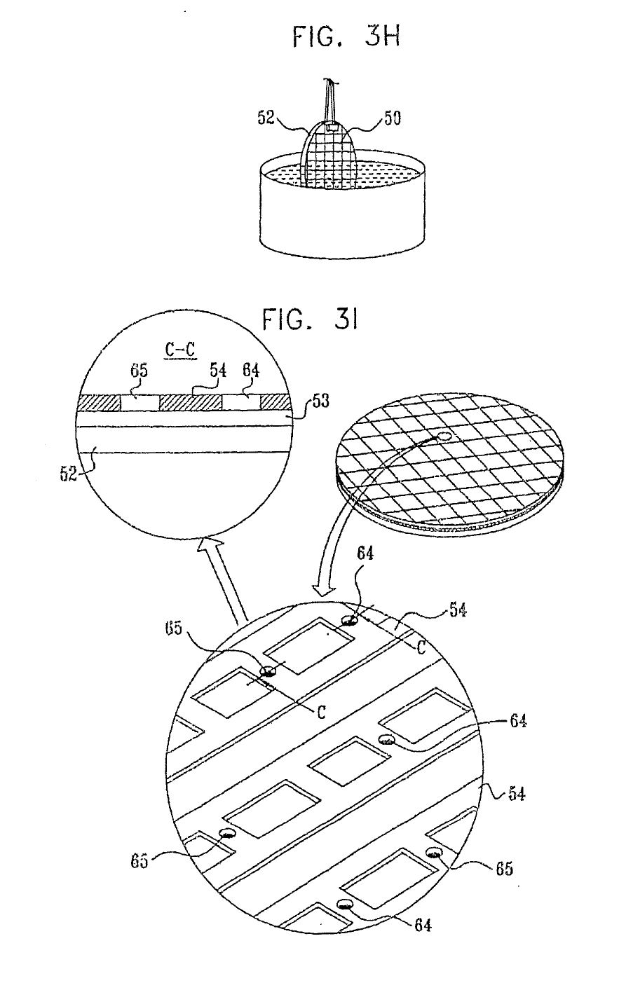

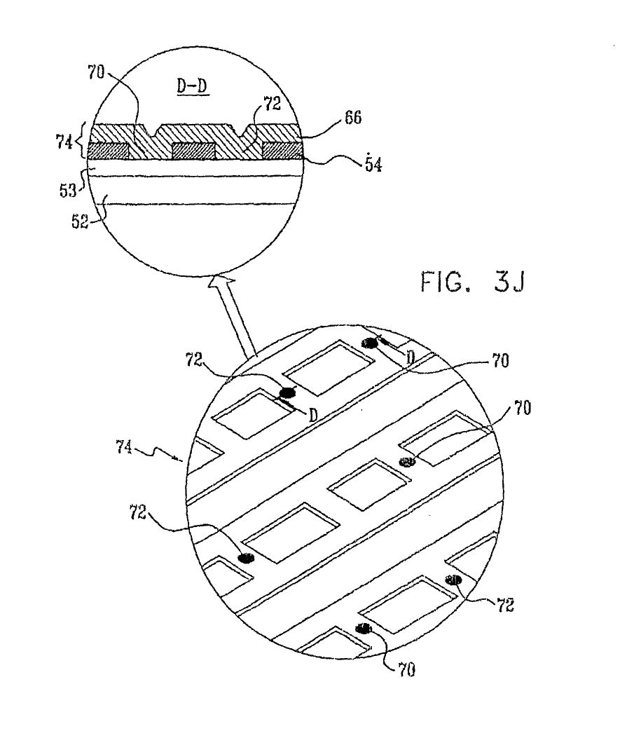

Reference is now made to FIGS. 3A, 3B, 3C, 3D, 3E, 3F, 3G, 3H, 3I and 3J, which are simplified pictorial illustrations illustrating various stages in laser mass customization of integrated circuits in accordance with another preferred embodiment of the present invention. Briefly stated, the difference between the methodology of FIGS. 2A-2I and that of FIGS. 3A-3J is that the customization in the embodiment of FIGS. 2A-2I is effected in one or more conductive layers, while in the embodiment of FIGS. 3A-3J, the customization is effected in one or more interconnect layer interconnecting conductive layers.

FIG. 3A illustrates an initial stage wherein a layer 50 of photoresist is formed on a wafer 52 not only having semiconductor elements formed thereon but also having at least one conductive layer 53 formed thereon over which a non-conductive layer 54 is formed. The photoresist layer 50 is formed over the non-conductive layer 54. FIG. 3B shows exposure of layer 50 by light from light source 55 via a mask 56 to form photoresist patterns 58 corresponding to vias in a die 60 on wafer 52.

FIG. 3C shows laser customization of layer 50 at die 60, which defines customization markings 62 at each die. Preferably, each die may be distinguished from every other die by the nature an/or location of the customization marking 62 thereon. In the embodiment of the invention described herein with reference to FIGS. 3A-3J, the customization markings 62 may be vias indistinguishable from conventional via markings 58 produced by the mask exposure of the photoresist layer described with reference to FIG. 3B, other than by their location.

Following the mask exposure step of FIG. 3B and the laser exposure step of FIG. 3C, the layer 50 may be developed in a conventional manner, as shown in FIG 3D. It is a particular feature of the invention that the laser customization need not require a separate or additional development step.

Reference is now made to FIG. 3E, which shows wafer 52 following the development step of FIG. 3D. It is noted that the laser customization step of FIG. 3C results, in the illustrated example, in customized via holes 64 in the photoresist layer 50 corresponding to customized vias in the interconnect layer, while the mask exposure of FIG. 3B results, in conventional via holes 65 in the photoresist layer 50.

Thus it may be appreciated that, similarly to the embodiment of FIGS. 2A-2I, each integrated circuit produced by the methodology described hereinabove may be not only visually distinct from every other integrated circuit but may also be electrically different, such that its identity may be ascertained electrically, as by electrical interconnection with pads thereof.

Following the conventional development step of FIG. 3D, the wafer 52 is subjected to a conventional etching step shown in FIG. 3F. The results of this conventional etching step are shown in FIG. 3G, where it is seen that via holes 64 and 65 are formed in non-conductive layer 54 in registration with the respective patterns 65 and 64, produced by the mask exposure stage of FIG. 3B and by the laser customization stage of FIG. 3C.

Following the conventional etching step shown in FIG. 3F, the wafer 52 is subjected to a conventional photoresist removal step shown in FIG. 3H which removes the photoresist layer 50, leaving the customized via holes 64 as well as via holes 65 defined by the mask exposure stage of FIG. 3B intact, as seen in FIG. 3I.

FIG. 3J illustrates a further step wherein a conductive layer 66 is formed over the non-conductive layer 54, by any suitable technique, such as sputtering. This step fills in the via holes 64 and 65, thus defining corresponding vias 70 and 72 in an interconnect layer 74, interconnecting conductive patterns in layers 53 and 66. It is understood that conductive layer 66 may be suitably patterned as by conventional photolithographic techniques.

The resulting interconnect layer 74 is thus seen to contain inter alia customized vias 70 and 72, in at least one interconnect layer, which enable each die to have a customized identity and/or electrical function.

It is appreciated that either or both of the functionalities of FIGS. 2A-2I and 3A-3J may be applied to one or more metal layer of a given wafer.

It will be appreciated by persons skilled in the art that the present invention is not limited by what has been particularly shown and described hereinabove. Rather the scope of the present invention includes both combinations and subcombinations of tho various features described hereinabove as well as variations and modifications which would occur to persons skilled in the art upon reading the specification and which are not in the prior art.

1. A methodology for laser mass customization of integrated circuits comprising;
providing a substrate;
forming at least one semiconductor layer over said substrate; and
forming a plurality of conductive layers over said semiconductor layer, wherein at least one of said plurality of conductive layers is individually customized by employing a laser.

2. A methodology for laser mass customization of integrated circuits according to claim 1 and wherein said forming comprises:
defining at least one of said plurality of conductive layers by exposing photoresist to light; and
individually customizing at least a portion of at least one of said plurality of conductive layers by causing laser light to impinge on said photoresist.

3. A methodology for laser mass customization of integrated circuits according to claim 2 and wherein said defining and said individually customizing each comprise exposing an area of said photoresist layer.

4. A methodology for laser mass customization of integrated circuits according to claim 3 and wherein an area exposed by said individually customizing is substantially smaller than an area exposed by said defining.

5. A methodology for laser mass customization of integrated circuits according to claim 3 and wherein said individually customizing has an overall duration which is substantially smaller than the overall duration of said defining.

6. A methodology for laser mass customization of integrated circuits according to claim 3 and wherein said individually customizing employs a beam having an intensity which is substantially greater than the intensity of light employed in said defining.

7. A methodology for laser mass customization of integrated circuits according to claim 4 and wherein said individually customizing has an overall duration which is substantially smaller than the overall duration of said defining.

8. A methodology for laser mass customization of integrated circuits according to claim 4 and wherein said individually customizing employs a beam having an intensity which is substantially greater than the intensity of light employed in said defining.

9. A methodology for laser mass customization of integrated circuits according to claim 3 and wherein exposure by said individually customizing is effected on the fly.

10. A methodology for laser mass customization of integrated circuits according to claim 4 and wherein exposure by said individually customizing is effected on the fly.

11. A methodology for laser mass customization of integrated circuits according to claim 5 and wherein exposure by said individually customizing is effected on the fly.

12. A methodology for laser mass customization of integrated circuits according to claim 6 and wherein exposure by said individually customizing is effected on the fly.

13. A methodology for laser mass customization of integrated circuits according to claim 7 and wherein exposure by said individually customizing is effected on the fly.

14. A methodology for laser mass customization of integrated circuits according to claim 8 and wherein exposure by said individually customizing is effected on the fly.

15. A methodology for laser mass customization of integrated circuits according to claim 3 and wherein said exposing which provides said individually customizing takes place generally concurrently with said exposing which provides said defining.

16. A methodology for laser mass customization of integrated circuits according to claim 4 and wherein said exposing which provides said individually customizing takes place generally concurrently with said exposing which provides said defining.

17. A methodology for laser mass customization of integrated circuits according to claim 5 and wherein said exposing which provides said individually customizing takes place generally concurrently with said exposing which provides said defining.

18. A methodology for laser mass customization of integrated circuits according to claim 6 and wherein said exposing which provides said individually customizing takes place generally concurrently with said exposing which provides said defining.

19. A methodology for laser mass customization of integrated circuits according to claim 7 and wherein said exposing which provides said individually customizing takes place generally concurrently with said exposing which provides said defining.

20. A methodology for laser mass customization of integrated circuits according to claim 8 and wherein said exposing which provides said individually customizing takes place generally concurrently with said exposing which provide said defining.

21. A methodology for laser mass customization of integrated circuits according to claim 9 and wherein said exposing which provides said individually customizing takes place generally concurrently with said exposing which provides said defining.

22. A methodology for laser mass customization of integrated circuits according to claim 10 and wherein said exposing which provides said individually customizing takes place generally concurrently with said exposing which provides said defining.

23. A methodology for laser mass customization of integrated circuits according to claim 11 and wherein said exposing which provides said individually customizing takes place generally concurrently with said exposing which provides said defining.

24. A methodology for laser mass customization of integrated circuits according to claim 12 and wherein said exposing which provides said individually customizing takes place generally concurrently with said exposing which provides said defining.

25. A methodology for laser mass customization of integrated circuits according to claim 13 and wherein said exposing which provides said individually customizing takes place generally concurrently with said exposing which provides said defining.

26. A methodology for laser mass customization of integrated circuits according to claim 14 and wherein said exposing which provides said individually customizing takes place generally concurrently with said exposing which provides said defining.

27. A methodology according to claim 1 and wherein said substrate comprises a silicon wafer including a plurality of integrated circuit dies and wherein each of said plurality of integrated circuit dies is individually customized by employing said laser.

28. A methodology according to claim 2 and wherein said substrate comprises a silicon wafer including a plurality of integrated circuit dies and wherein each of said plurality of integrated circuit dies is individually customized by employing said laser.

29. A methodology according to claim 3 and wherein said substrate comprises a silicon wafer including a plurality of integrated circuit dies and wherein each of said plurality of integrated circuit dies is individually customized by employing said laser.

30. A methodology according to claim 4 and wherein said substrate comprises a silicon wafer including a plurality of integrated circuit dies and wherein each of said plurality of integrated circuit dies is individually customized by employing said laser.

31. A system for laser mass customization of integrated circuits comprising:
a mask exposure subsystem operative to configure at least one conductive layer forcing part of an integrated circuit; and
a laser customization subsystem operative to individually customize said at least one conductive layer.

32. A system according to claim 31 and wherein said mask exposure subsystem and said laser customization subsystem are both operative waferwise on a substrate containing a plurality of integrated circuit dies.

33. A system according to claim 31 and wherein said mask exposure subsystem and said laser customization subsystem operate at at least partially overlapping times on a given conductive layer.

34. A system for laser mass customization of integrated circuits according to claim 31 and wherein said mask customization subsystem is operative to configure said at least one conductive layer by exposing photoresist to light; and wherein
said laser customization subsystem is operative to further configure said at least one conductive layer by causing laser light to impinge on said photoresist.

35. A system for laser mass customization of integrated circuits according to claim 32 and wherein said mask customization subsystem is operative to configure said at least one conductive layer by exposing photoresist to light; and wherein
said laser customization subsystem is operative to further configure said at least one conductive layer by causing laser light to impinge on said photoresist.

36. A system for laser mass customization of integrated circuits according to claim 33 and wherein said mask customization subsystem is operative to configure said at least one conductive layer by exposing photoresist to light; and wherein
said laser customization subsystem is operative to further configure said at least one conductive layer by causing laser light to impinge on said photoresist.

37. A system for laser mass customization of integrated circuits according to claim 31 and wherein said mask customization subsystem employs light having an intensity which is substantially less than the intensity of a beam of light employed by said laser customization subsystem.

38. A system for laser mass customization of integrated circuits according to claim 31 and wherein said laser customization subsystem is operative on the fly.

39. A system for laser mass customization of integrated circuits according to claim 31 and therein said laser customization subsystem includes a customization engine providing customization outputs to a laser for making individual customization markings on each of a plurality of integrated circuit dies.

40. A system for laser mass customization of integrated circuits according to claim 31 and wherein said laser customization subsystem customizes at least one conductive layer.

41. A system for laser mass customization of integrated circuits according to claim 31 and wherein said laser customization subsystem customizes at least one interconnect layer.

42. A system for laser mass customization of integrated circuits according to claim 41 and wherein said laser customization subsystem customizes at least one interconnect layer.

43. A system for laser mass customization of integrated circuits according to claim 32 and wherein said mask customization subsystems employs light having an intensity which is substantially less than the intensity of beam of light employed by said laser customization subsystem.

44. A system for laser mass customization of integrated circuits according to claim 32 and wherein said laser customization subsystem is operative on the fly.

45. A system for laser mass customization of integrated circuits according to claim 32 and wherein said laser customization subsystem includes a customization engine providing customization outputs to a laser for making individual customization markings on each of a plurality of integrated circuit dies.

46. A system for laser mass customization of integrated circuits according to claim 32 and wherein said laser customization subsystem customizes at least one conductive layer.

47. A system for laser mass customization of integrated circuits according to claim 32 and wherein said laser customization subsystem customizes at least one interconnect layer.

48. A system for laser mass customization of integrated circuits according to claim 46 and wherein said laser customization subsystem customizes at least one interconnect layer.

49. A system for laser mass customization of integrated circuits according to claim 33 and wherein said mask customization subsystem employs light having an intensity which is substantially less than the intensity of a beam of light employed by said laser customization subsystem.

50. A system for laser mass customization of integrated circuits according to claim 33 and wherein said laser customization subsystem is operative on the fly.

51. A system for laser mass customization of integrated circuits according to claim 33 and wherein said laser customization subsystem includes a customization engine providing customization outputs to a laser for making individual customization markings on each of a plurality of integrated circuit dies.

52. A system for laser mass customization of integrated circuits according to claim 33 and wherein said laser customization subsystem customizes at least one conductive layer.

53. A system for laser mass customization of integrated circuits according to claim 33 and wherein said laser customization subsystem customizes at least one interconnect layer.

54. A system for laser mass customization of integrated circuits according to claim 52 and wherein said laser customization subsystem customizes at least one interconnect layer.
